(19) United States
(12) Patent Application Publication
(10) Pub. No.: US 2011/0058361 A1
(43) Pub. Date: Mar. 10, 2011

(54) LANTERN APPARATUS

(75) Inventor: Stephen HOUGHTON, Newcastle upon Tyne (GB)

(73) Assignee: BLACK & DECKER INC., Newark, DE (US)

(21) Appl. No.: 12/876,406

(22) Filed: Sep. 7, 2010

(30) Foreign Application Priority Data
Sep. 9, 2009 (EP) 09 169 798.7

(51) Int. Cl. F21L 4/02

(52) U.S. Cl. 362/184

(57) ABSTRACT

A lantern apparatus including a main housing including a lamp and a reflector, and a plurality of flashlights that are removably engageable with the main housing. The apparatus is arranged such that when the flashlights are engaged with the main housing they are spaced apart from the reflector and oriented so that light emitted from the flashlights is reflected by the reflector. Both the reflected light from the flashlights, and light emitted by the lamp, is emitted from the main housing.

### CROSS REFERENCE TO RELATED APPLICATIONS

This application claims the benefit of foreign priority of European Application No. 09 169 789.7 filed Sep. 9, 2009,

### BACKGROUND OF THE INVENTION

The present invention relates to a lantern apparatus for indoor or outdoor use, but which is especially convenient for outdoor use.

U.S. Pat. No. 4,004,132 discloses a toy camping set which includes a flashlight and lantern combination. The lantern includes a base structure having a receptacle for removably receiving and holding the flashlight with the beam of light from the flashlight directed generally downwardly when the lantern is held in its normal upright position. Connecting the receptacle with the base structure is a hollow tapered portion that is either translucent or transparent, and which surrounds a conical reflector. The flashlight includes a translucent or transparent lens member extending forwardly of its light bulb, and the forward (lower) end of the lens member fits on a shoulder of the reflector such that it completely surrounds the conical part of the reflector. In use, light emitted by the bulb of the flashlight is reflected by the conical reflector and travels through the lens member of the flashlight and through the hollow tapered portion, thereby escaping from the lantern.

### SUMMARY OF THE INVENTION

One aspect of the present application relates to providing an improved lantern apparatus.

According to one aspect, the present invention provides a lantern apparatus, comprising: a main housing including a lamp and a reflector; and a plurality of flashlights that are removably engageable with the main housing; the apparatus arranged such that when the flashlights are engaged with the main housing they are spaced apart from the reflector and oriented so that light emitted from the flashlights is reflected by the reflector, the apparatus also being arranged such that both reflected light from the flashlights (reflected by the reflector), and light emitted by the lamp, is emitted from the main housing.

Exemplary embodiments of the lantern apparatus of the present application may have several advantages over the flashlight and lantern combination of U.S. Pat. No. 4,004,132. In exemplary embodiments of the present application, the flashlights are spaced apart from the reflector when they are engaged with the main housing. This means, firstly, that it is not necessary to provide the flashlights with a special forwardly extending lens member to enable light reflected from the reflector to escape, and instead the flashlights can have a more conventional (and compact) design. Secondly, in contrast with the arrangement in U.S. Pat. No. 4,004,132, spacing the flashlights from the reflector enables more than one flashlight to be provided, thereby enhancing the illumination from the lantern, and also enabling more than one person at a time to use a flashlight (when removed from the apparatus). The latter feature can be especially useful when camping, etc. Thirdly, spacing the flashlights from the reflector can improve both the intensity and spread of reflected illumination from the flashlights, because it enables greater freedom in the design of the reflector and its positioning relative to the flashlights, and also because the illumination can be provided by more than one flashlight. Fourthly, spacing the flashlights from the reflector enables a lamp also to be provided in the main housing, for example at least partially in and/or on the reflector. This has the further advantages of enabling yet brighter illumination and enabling one or more of the flashlights to be removed or turned off (e.g. to conserve power) as and when desired, while still enabling the lantern apparatus to provide illumination. Additional advantages may be apparent from the following description and claims.

The main housing may have at least one opening into which each flashlight may be at least partially inserted in order to engage with the main housing. The opening(s) may be permanently open, or may have a cap or other closure that can be moved to gain access thereto. The flashlights may engage with the main housing in the opening(s).

In exemplary embodiments of the invention, the main housing includes a cavity in which the reflector is located, and through which light emitted by the flashlights travels before striking the reflector. The cavity may have a transparent or translucent wall through which the light emitted from the main housing travels (i.e. light emitted by the flashlights and reflected from the reflector, and light emitted by the lamp). The opening(s) of the main housing may be located at an end of the cavity (e.g. an upper end, according to a normal orientation of the main housing, in use). The reflector may be located at or near an opposite end of the cavity to the end at which the opening(s) is/are located (e.g. a lower end). The flashlights may extend at least partially into the cavity when they are engaged with the main housing, e.g. in a generally downwardly-pointing orientation (i.e. with their light beams directed generally downwards). The flashlights may, for example, engage with the housing by an interference fit (e.g. assisted by gravity) or by an interlocking engagement. Each flashlight may be arranged (e.g. sized and shaped) to have an interference fit with a respective opening.

The reflector may have an at least partially reflective surface that is concave and/or convex and/or flared and/or at least partially conical. For example, the reflector may have a generally domed (or partially domed) shape, or it may be generally conical (or frusto-conical), or flared conical/frusto-conical. However, other shapes of reflector are possible. The lamp may be situated at least partially in and/or on the reflector.

The lamp may include a transparent or translucent cover through which at least a portion of its light is emitted. The lamp cover may, for example, be located on, or adjacent to, the reflective surface of the reflector.

In some embodiments of the invention, the lamp cover may comprise at least a portion of the reflector, e.g. at least a portion of the reflective surface of the reflector. At least that portion of the reflective surface may be partially reflective and partially transmissive to light, thereby reflecting at least some of the light from the flashlights while allowing at least some of the light from the lamp to escape.

The flashlights may be are battery powered, and may hold their own batteries (which may, or may not, be rechargeable). The lamp may be powered by mains electricity, but preferably it is battery powered (either instead of, or in addition to, being mains powered). Consequently, the lantern apparatus may further comprises a part of the housing arranged to accommodate a portable power supply for the lamp.

Each flashlight may include a handle portion, the handle portions extending at least partially out of the housing when the flashlights are engaged therewith. The handle portion of each flashlight may include an actuation switch for the flashlight (e.g. on an end of the handle portion), which is accessible from the exterior of the housing when the flashlight is engaged therewith.

In at least some embodiments of the invention, the lantern apparatus may include electrical contacts on at least one of the flashlights (but preferably on each of them) and on the main housing, such that the flashlight(s) can be in electrical contact with components in the main housing when engaged therewith. For example, the main housing may include a battery charger, arranged to charge one or more flashlight batteries when the flashlight(s) is/are engaged with the main housing. The charger may additionally or alternatively be arranged to charge one or more batteries for powering the lamp.

The lantern apparatus (especially the main housing) preferably includes a base by which the apparatus may be supported on a surface. Preferably the transparent or translucent wall of the cavity is mounted on the base. The base may, for example contain a portable power supply (e.g. one or more batteries) for the lamp and/or charging circuitry, e.g. for the lamp batteries and/or for the flashlight batteries.

In some exemplary embodiments of the invention, the lantern apparatus may include at least one light (e.g. one or more light emitting diodes, or other light emitter(s)) arranged to illuminate automatically when an AC mains electrical power supply to the lantern is interrupted (e.g. in the event of a power failure). For example, the light (which may be described as an emergency light) may be powered by one or more rechargeable batteries, and in use may be connected to the mains electricity supply, e.g. via a battery charger. The emergency light may be additional to the lamp and/or (in some embodiments of the invention) it may be the lamp itself.

The lantern apparatus (especially the main housing) may include a handle by which the apparatus may be carried. The handle and/or another part of the main housing may include a hook or other attachment device for attaching the lantern apparatus to another structure.

The main housing may be formed entirely or in part from polymeric materials.

The light emitting components of the flashlights and the lamp may be, for example, incandescent bulbs and/or fluorescent bulbs and/or light emitting diodes (LEDs), or substantially any suitable electrically powered components. Light emitting diodes (especially bright white light emitting LEDs) currently are particularly preferred, because they are highly efficient and generate very little heat.

### BRIEF DESCRIPTION OF THE DRAWINGS

Exemplary embodiments of the invention will now be described, by way of example, with reference to the accompanying drawings, of which:

FIG. 1 ((a) to (c)) shows three views of a first embodiment of a lantern assembly according to the invention; and

FIG. 2 ((a) to (d)) shows four views of a second embodiment of a lantern assembly according to the invention, and parts thereof.

### DETAILED DESCRIPTION OF EXEMPLARY EMBODIMENTS OF THE INVENTION

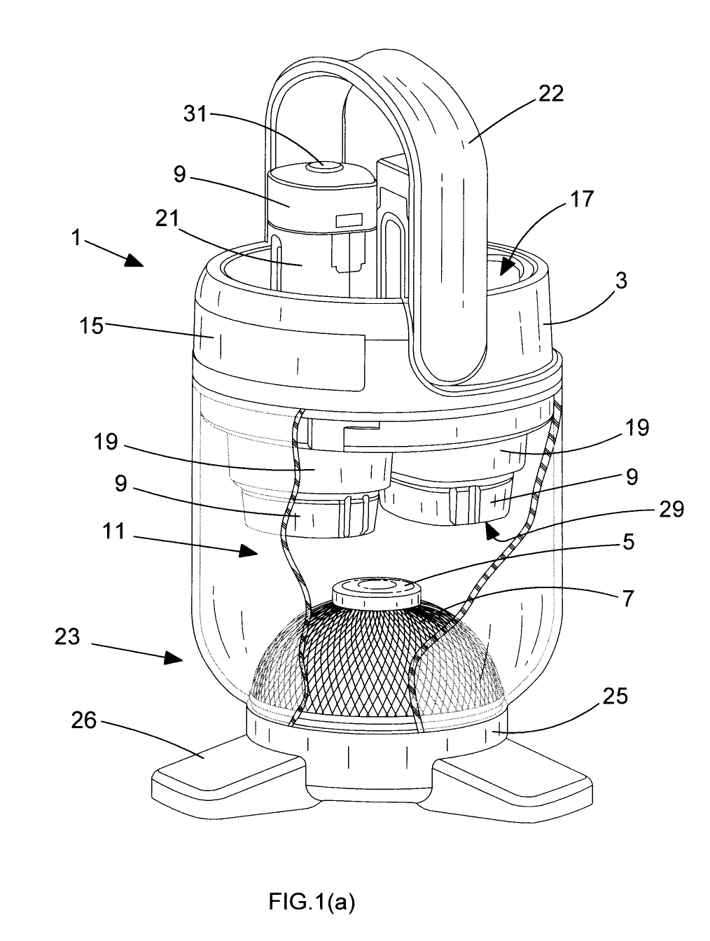

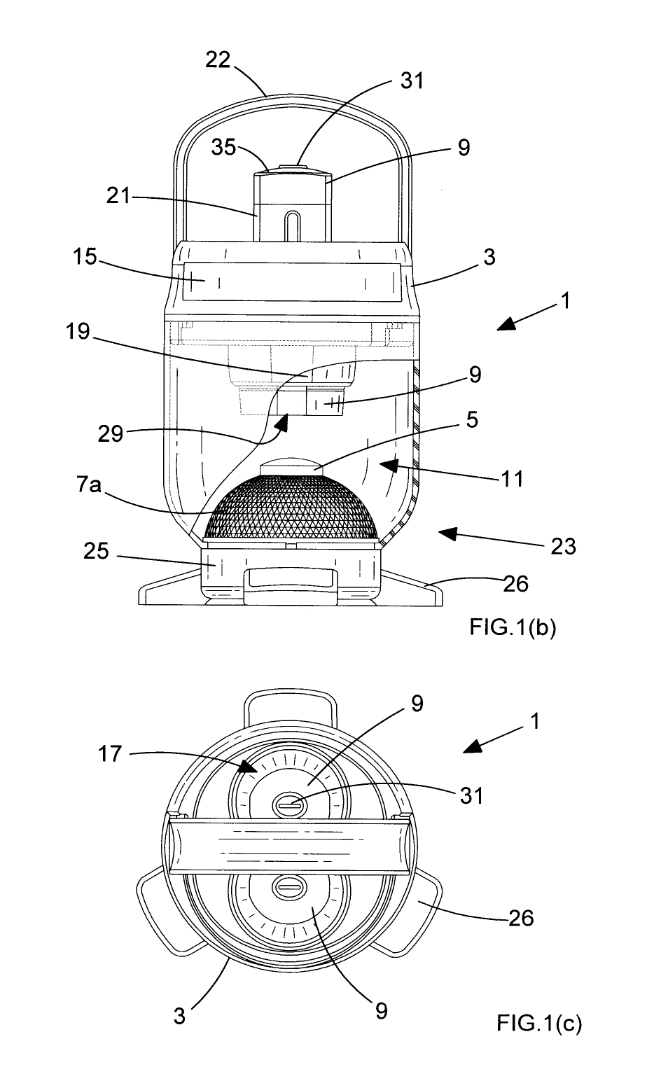

FIG. 1 shows a lantern apparatus 1 according to an exemplary embodiment of the invention, comprising a main housing 3 which includes a lamp 5 and a reflector 7, and two flashlights 9. The main housing 3 defines a cavity 11 having a transparent or translucent side wall 13 which, in the illustrated embodiment, is generally cylindrical in shape. An upper end 15 of the main housing 3 includes a pair of openings 17, each of which is arranged to receive a respective flashlight 9. The openings 17 extend, by means of extensions 19, into the cavity 11, and the flashlights 9 and the openings are arranged so that the flashlights are engaged with the main housing in the openings by means of a gravity-assisted interference fit. Thus, each flashlight 9 is removable from its respective opening 17 by grasping a handle portion 21 of the flashlight and pulling it upwardly with respect to the main housing 3. After each flashlight has been used (independently of the remainder of the lantern assembly) it may be returned to the main housing by inserting it into a respective opening 17.

The upper end 15 of the main housing 3 also includes a pivoting handle 22 by which the lantern apparatus may be lifted and carried. A hook or other attachment member may also be provided, for example on the handle 22, for attaching the lantern apparatus to other structures.

Towards a lower end 23 of the main housing 3, inside the cavity 11, are the lamp 5 and reflector 7. The reflector 7 comprises a reflective (e.g. mirrored) dome, the top part of which supports the lamp 5. The lamp 5 includes a transparent or translucent cover which covers one or more light emitting components, preferably light emitting diodes (but other light emitters, such as incandescent or fluorescent bulbs can be used). Components of the lamp 5 and its electrical circuitry are housed within the reflector 7.

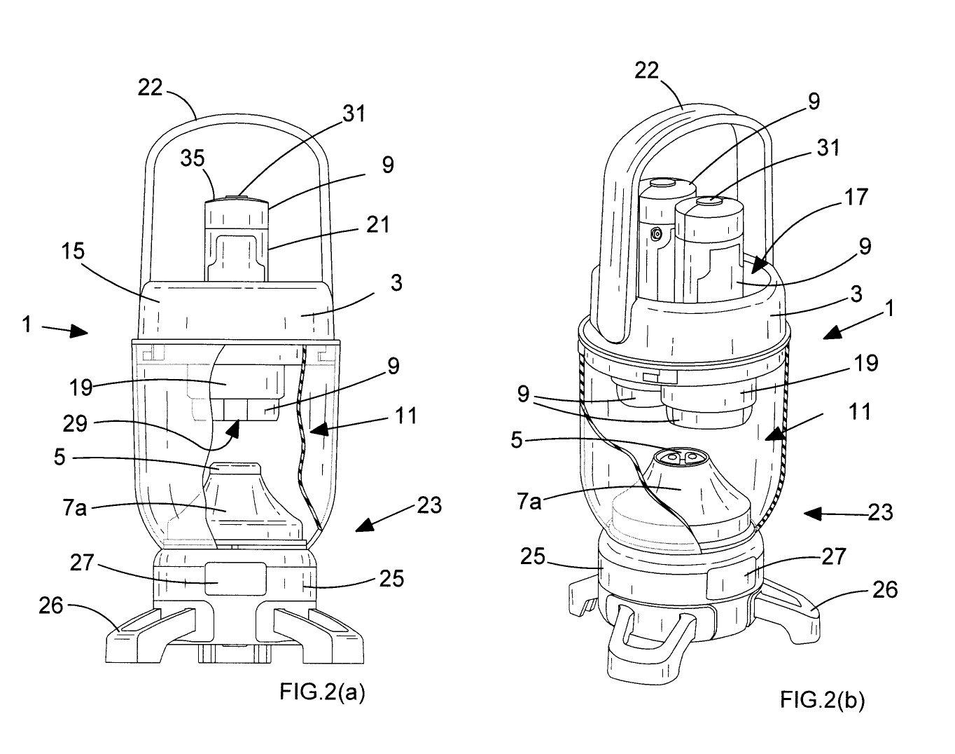

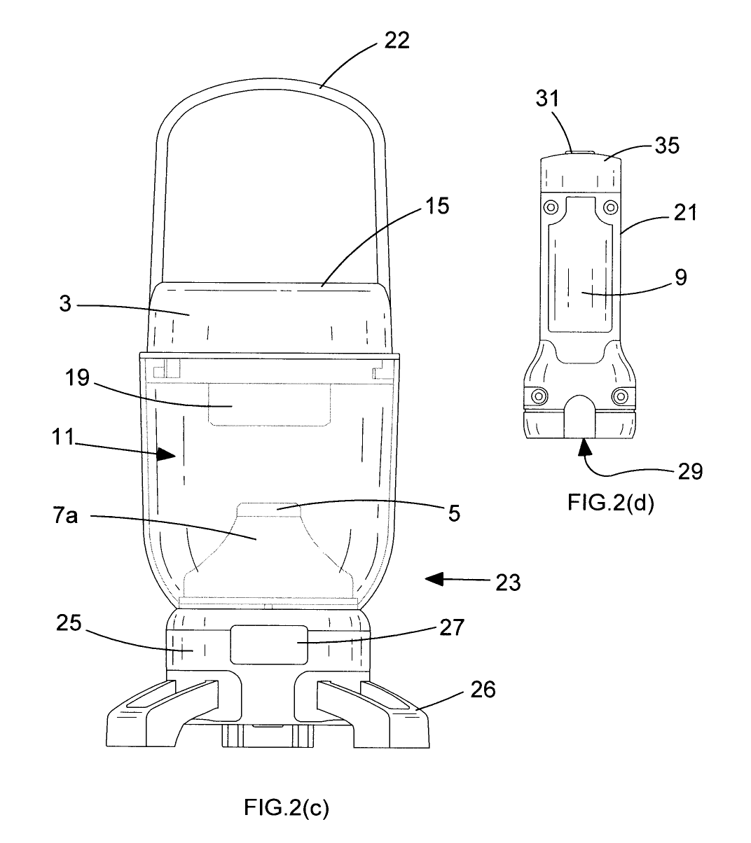

In some embodiments of the invention, the reflector 7 as shown in FIG. 1 (and/or FIG. 2) may be at least partially transmissive to light from its interior, so that at least part of the lamp 5 may be located inside the reflector and emit at least some of its light through the reflector. Thus, in some versions of the invention, the reflector 7 may be partially reflective, e.g. a faceted transparent or translucent structure arranged to refract and reflect light. However, it is generally preferred for the reflector not to be transmissive of light there through, but instead to reflect light from its exterior, and to have the light emitting part of the lamp 5 adjacent to its exterior.

Below the reflector 7 and the transparent or translucent wall 13 is a base 25 of the main housing 3, which supports the remainder of the main housing (and the flashlights when they are engaged with the main housing). The base 25 includes three supporting legs 26, and accommodates one or more batteries for the lamp 5. The base 25 and/or the reflector 7 may also house electrical charging circuitry for charging the batteries. In at least some versions, a mains electrical power cable may extend from the base 25, for powering the lamp 5 and/or the charger.

FIG. 2 (views (a) to (d)) illustrates a second embodiment of the invention which is substantially the same as the embodiment illustrated in FIG. 1 (views (a) to (c)), but which has a differently shaped reflector 7a. In the FIG. 2 embodiment, the reflector 7a has the shape of a truncated flared cone, with the lamp 5 sitting on top of the truncated region. FIG. 2 also shows an actuating switch 27 for the lamp 5 on the base 25. (The FIG. 1 embodiment also has a switch for the lamp 5 on the base 25, but it is not illustrated.)

As illustrated, both versions of the lantern apparatus 1 are arranged such that when the flashlights 9 are engaged with the main housing they are spaced apart from the reflector 7, 7a and oriented so that light emitted (downwardly as drawn) from the flashlights is reflected by the reflector. Both reflected light from the flashlights 9, and light emitted by the lamp 5, is emitted from the main housing 3 through the transparent or translucent wall 13.

FIG. 2c shows the lantern apparatus with the flashlights 9 removed, and FIG. 2d shows one of the removed flashlights 9. Each flashlight 9 is generally conventional in shape and construction, being generally elongate and having a forward light emitting part 29, the handle portion 21 behind this, which handle portion houses batteries for powering the flashlight, and a push-button actuating switch 31 on a rear end 35 of the flashlight housing. This arrangement enables the flashlights to be easily withdrawn from, and inserted into, the main housing 3 of the lantern apparatus, and to be switched on and off when they are engaged with the main housing.

It will be understood that the above description and the drawings are of particular examples of the invention, but that other examples of the invention are included in the scope of the claims.

1. A lantern apparatus, comprising: a main housing including a lamp and a reflector; and a plurality of flashlights that are removably engageable with the main housing; wherein when the flashlights are engaged with the main housing they are spaced apart from the reflector and oriented so that light emitted from the flashlights is reflected by the reflector, and wherein light reflected from the flashlights, and light emitted by the lamp, is emitted from the main housing.

2. A lantern apparatus according to claim 1, in which the main housing has at least one opening into which each flashlight may be at least partially inserted in order to engage with the main housing.

3. A lantern apparatus according to claim 2, wherein the main housing includes a cavity in which the reflector is located, and through which light emitted by the flashlights travels before striking the reflector.

4. A lantern apparatus according to claim 3 wherein the at least one opening is located at an end of the cavity.

5. A lantern apparatus according to claim 4, wherein the reflector is located at or near an opposite end of the cavity to the end at which the at least one opening is located.

6. A lantern apparatus according to claim 3, wherein the flashlights extend at least partially into the cavity when they are engaged with the main housing.

7. A lantern apparatus according to claim 3, wherein the cavity has a wall which is at least one of transparent and translucent and through which the light emitted from the main housing travels.

8. A lantern apparatus according to claim 1, wherein the flashlights engage with the housing by an interference fit or by an interlocking engagement.

9. A lantern apparatus according to claim 1, wherein the reflector has an at least partially reflective surface that is at least one of concave, convex, flared, and at least partially conical.

10. A lantern apparatus according to claim 1, wherein the lamp is situated at least one of at least partially in the reflector and at least partially on the reflector.

11. A lantern apparatus according to claim 1, wherein the lamp includes a cover through which at least a portion of its light is emitted.

12. A lantern apparatus according to claim 11, wherein the cover is located at least one of on the reflective surface of the reflector and adjacent to the reflective surface of the reflector.

13. A lantern apparatus according to claim 1, further comprising a part of the housing arranged to accommodate a portable power supply for the lamp.

14. A lantern apparatus according to claim 1, wherein each flashlight includes a handle portion, the handle portions extending at least partially out of the housing when the flashlights are engaged with the main housing.

15. A lantern apparatus according to claim 14, wherein the handle portion of each flashlight includes an actuation switch for the flashlight, which is accessible from the exterior of the housing when the flashlight is engaged with the main housing.

16. A lantern apparatus according to claim 11, wherein the cover comprises at least a portion of the reflector.
